(19) United States
(12) Patent Application Publication
(10) Pub. No.: US 2005/0017419 A1
(43) Pub. Date: Jan. 27, 2005

(54) Level controllable air spring

(76) Inventor: Jens-Uwe Gleu, Langenhagen (DE)

Correspondence Address: Walter Ottesen;Patent Attorney, P.O. Box 4026, Gaithersburg, MD, 20885-4026, US

(21) Appl. No.: 10/834,983

(22) Filed: Apr. 30, 2004

(30) Foreign Application Priority Data
May 2, 2003 (DE) 103 19 669.2

(51) Int. Cl. F16F 5/00

(52) U.S. Cl. 267/113

(57) ABSTRACT

A level controllable air spring (2) has two end members (air spring cover plate (4) and air spring piston (6)), which are at a distance to each other which varies. The two end members (6, 8) are connected to each other via a rolling lobe flexible member (8) and a helical or spiral spring (14), which is subject to tension load, or a band (14) made of elastomeric material which is also subjected to tension load. In order to allow for a nonmagnetic measurement of the length (elevation) within the air spring (2), the elastic element (14) includes a mechanical-electrical sensor (20), which can be a resistance strain gauge and which is, in another preferred embodiment, integrated into a measuring circuit, which is in the form of an electrical resistance bridge. The measuring circuit can be integrated into a control apparatus of the air spring system. The sensor (20), which can be used for any air spring applications, can fully replace known level sensors and is able to perform multiple functions.

### CROSS REFERENCE TO RELATED APPLICATION

This application claims priority of German patent application no. 103 19 669.2, filed May 2, 2003, the entire content of which is incorporated herein by reference.

### FIELD OF THE INVENTION

The invention relates to a level controllable air spring including two end members at a variable distance from each other, at least one flexible member and at least one resilient element. The flexible member and the resilient element connect the end members, whose distance to each other varies. The resilient element can be a helical spring, a spiral spring or a band made of elastomeric material. To optimize their usage, air springs are equipped with level control systems, which generally require the use of an elevation sensor.

### BACKGROUND OF THE INVENTION

An elevation sensor used in CONTITECH air spring systems includes a pair of mutually opposed conical springs which are placed under tension between the cover plate and the piston of the air spring. With a change in the clear distance of the interior space of the air spring there results a proportional change in the inductivity of the more or less extended conical springs. It is well known in the art to use the inductivity of extendable helical springs to measure length or height. In this connection, reference can be made, for example, to German patent publications: 3,635,787; 4,437,939; 2,211,359; and, 3,205,705.

According to one embodiment of the air spring described in German patent publication 100 23 622, an elastic band is placed under tension between the end members which are at a variable distance from each other. This band is permeated with ferromagnetic particles and forms part of a magnetic circuit. When the length of the band changes as a result of a change in the elevation of the spring, the cross section of the band changes which, in turn, results in a change of the magnetic resistance or reluctance.

Although the present invention also utilizes an elastic element which is placed under tension between the distance variable end members, the present invention, however, seeks to measure the elevation of air springs without evaluating magnetic or electromagnetic phenomena.

German patent publication 199 56 009 describes a method of measuring the distance between two points, namely A and B, which are at a spacing from each other. For this purpose, the two ends of a flexible rod are connected to points A and B, respectively. Reducing the distance between A and B results in bending of the originally straight rod into an approximate C-shape or S-shape. A curvature of the original straight-line rod axis occurs.

The expansion of the convex side of the rod and/or the compression of the concave side of the rod can be determined with a resistance strain gauge. The measurements of the resistance strain gauge can be brought into relationship with the distance (length) between A and B.

### SUMMARY OF THE INVENTION

It is the object of the invention to provide for the non-magnetic measurement of the length (elevation) within an air spring, wherein the sensing element does not exclusively rely on compression, but, preferably functions in response to tension load.

The extent of elastic deformation of an elastic element, such as a helical spring, which is mounted between the end members of the air spring, is the basis for measuring the instantaneous clear height of the interior of the air spring in one preferred embodiment. The extent of deformation is hereby electrically detected via a mechanical-electrical converter which is attached to the elastic element.

The path coupling of the attachment points of the elastic element to the air spring reduces the measurement results to a measurement of the deformation, which can be measured directly, for example, via a resistance strain gauge. In a preferred embodiment, it is not necessary to evaluate the force associated with the deformation which, in turn, renders material fatigue of the elastic element irrelevant. In fact, in this embodiment, the actual instantaneous length of the air spring is measured directly, rather than being first converted into another signal or the like, thus only being measured indirectly.

The elastic element of the invention has, in a preferred embodiment, a certain pretension and is preferably exclusively subjected to tension load. This results in a substantially linear characteristic line.

The configuration without the force of pressure prevents the elastic element from kinking and stabilizes the inherent dynamic transverse movements. Using a helical or spiral spring as the elastic element renders the invention very cost effective.

The mechanical-electrical sensor is preferably a resistance strain gauge (RSG), which has been attached with adhesive to the elastic helical spring, which can, for example, be a simple steel spring. Such an attachment of a resistance strain gauge can be industrially mass produced.

The attachment of the resistance strain gauge, which might be sensitive to humidity and mechanical influences, is, in a preferred embodiment, protected by the dried atmosphere provided in the interior space of the air spring.

The mechanical-electrical sensor, which is integrated into the elastic element, can be connected in series or parallel to the elastic element.

In other preferred embodiments, a bending sensor or a torsion sensor can be used in lieu of the resistance strain gauge.

To keep the temperature dependence as low as possible, the resistance strain gauge may, in a preferred embodiment, be integrated into a temperature compensated electrical measuring bridge.

The measuring bridge amplifier can, in this embodiment, be part of the control apparatus, which is part of the air spring system.

In a preferred embodiment, the attachment of a temperature compensated resistance strain gauge bridge onto the elastic element is performed in a separate manufacturing step, allowing for a robust and cost efficient attachment.

In another preferred embodiment, the amplifying circuit required for the measurement is integrated, basically without added expense, into the control apparatus which is, in any event, a part of the air spring system.

The sensor according to the invention can be used for any air spring application, including, but not limited to, trucks and other commercial vehicles, rail cars, drivers cab, machinery supports and can fully replace known level sensors. The sensor of the invention also shares the ability of those known sensors to be multi functional (skyhook sensing of the axle movement, headlight leveling signal transducers, et cetera).

### BRIEF DESCRIPTION OF THE DRAWING

FIG. 1 shows an embodiment of an air spring according to the invention in longitudinal section.

FIGS. 2a and 2b show two configurations of a mechanical-electrical sensor according to the invention. In the embodiment shown, the electrical sensor is integrated into a measuring circuit which is in the form of an electrical resistance bridge.

FIGS. 3a and 3b show two further configurations of a mechanical-electrical sensor according to the invention. In the embodiment shown, the sensor is integrated into a control apparatus (ECU) of an air spring system.

### DESCRIPTION OF THE PREFERRED EMBODIMENTS OF THE INVENTION

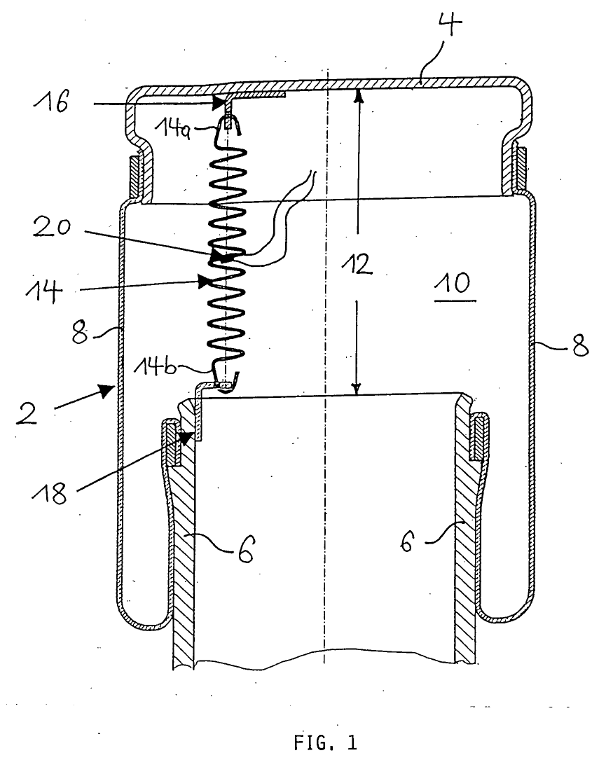

The air spring of FIG. 1 includes two end members 4, 6 (air spring cover plate 4 and air spring piston 6), which are connected to each other via a rolling lobe flexible member 8, thereby enclosing the interior space 10 of the air spring. The distance between the end members is variable.

To determine the clear elevation 12 of the interior space 10 of the air spring, an elastic element 14 is, in a preferred embodiment, placed under tension between the two end members. In FIG. 1, the elastic element 14 is a helical spring which can be subjected to tension load. Alternatively, a spiral spring or a band made of elastomeric material can be used. One end 14a of the elastic element 14 is attached to the cover plate via a connection in the form of a bracket 16, while the other end 14b is attached to the piston 6 via a further connection in the form of a bracket 18.

In the embodiment shown, a mechanical-electrical sensor is applied. Here, a resistance strain gauge 20 is attached to the helical spring 14 with an adhesive.

A change of the length of the helical spring 14 as a result of a change in elevation of the air spring 12 or the elevation of a vehicle incorporating the air spring of the invention results in the expansion or torsion of the resistance strain gauge 20, which can be measured as a change of electrical resistance thereof. The electrical resistance representing the elevation of the air spring 12 is the basis for the level control of the air spring 2.

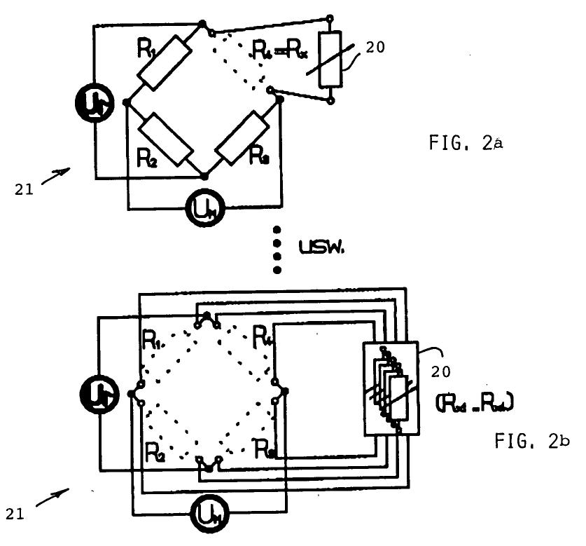

To keep the temperature dependance as low as possible, the mechanical-electrical sensor 20 can, in a preferred embodiment, be integrated into a temperature compensated electrical measuring bridge 21 as shown in FIGS. 2a and 2b. The electrical resistance bridge shown in FIGS. 2a and 2b is temperature compensated when it takes the form of a full bridge.

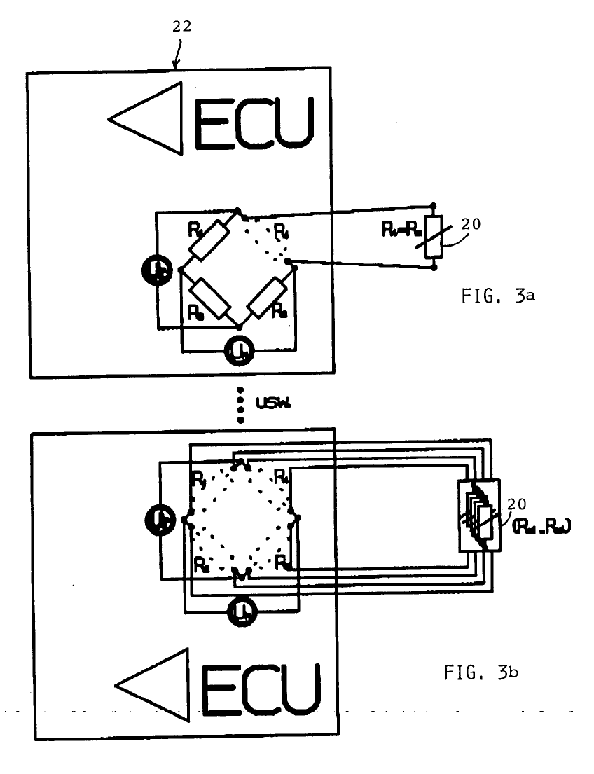

As shown in FIGS. 3a and 3b, the measuring bridge amplifier can, in this embodiment, be part of the control apparatus 22, which is part of the air spring system.

It is understood that the foregoing description is that of the preferred embodiments of the invention and that various changes and modifications may be made thereto without departing from the spirit and scope of the invention as defined in the appended claims.

1. A level controllable air spring comprising:
two end members disposed at a distance from each other and said end members being displaceable relative to each other so as to cause said distance to vary;
a flexible resilient member connected between said end members;
a resilient element connected between said end members; and,
said resilient element including a mechanical-electrical sensor.

2. The level controllable air spring of claim 1, wherein said elastic element is a helical spring or a spiral spring or a band made of elastomeric material.

3. The air spring of claim 1, wherein said air spring deflects and expands over a predetermined spring range; and, said elastic element has a predetermined unstressed length and is so dimensioned in said unstressed length so as to cause said elastic element to be loaded exclusively in tension over all of said spring range.

4. The air spring of claim 1, wherein the mechanical-electrical sensor is integrated into the elastic element.

5. The air spring of claim 1, wherein the mechanical-electrical sensor is connected in series or parallel to the elastic element.

6. The air spring of claim 1, wherein the mechanical-electrical sensor is a resistance strain gauge.

7. The air spring of claim 1, wherein the mechanical-electrical sensor is a bending sensor or a torsion sensor.

8. The air spring of claim 1, wherein the mechanical-electrical sensor is integrated into a measuring circuit which is in the form of an electrical resistance bridge.

9. The air spring of claim 7, wherein the measuring circuit is integrated into a control apparatus of an air spring system.

10. The air spring of claim 7, wherein the electrical resistance bridge is temperature compensated.
